(19) United States
(12) Patent Application Publication
(10) Pub. No.: US 2024/0287415 A1
(43) Pub. Date: Aug. 29, 2024

(54) LIQUID PHOSPHATE-FREE DETERGENT COMPOSITION FOR THE REDUCTION OF MICROFIBER RELEASE

(71) Applicants: BASF SE, Ludwigshafen am Rhein (DE); INDUSTRIA DE DISENO TEXTIL S.A., Arteixo (ES)

(72) Inventors: Nuria BONASTRE GILABERT, Barcelona (ES); Maria ` DE MORAGAS, Barcelona (ES); Antoine Maxime Charles Joseph BEZIAU, Ludwigshafen (DE); Juergen FRANKE, Ludwigshafen (DE); Gerhard MERKLE, Ludwigshafen (DE); Hector Alonso FERNANDEZ, Arteixo (ES); Feliz Poza PENA, Arteixo (ES)

(21) Appl. No.: 18/571,035

(22) PCT Filed: Jun. 14, 2022
(86) PCT No.: PCT/EP22/66243

§ 371 Date: Dec. 15, 2023

(30) Foreign Application Priority Data
Jul. 14, 2021 (EP) 21382636.5

(51) Int. Cl. C11D 3/33; C11D 1/29; C11D 1/66; C11D 1/831; C11D 3/20

(52) U.S. Cl. CPC C11D 3/33; C11D 1/29; C11D 1/662; C11D 1/831; C11D 3/2086; C11D 2111/12

(57) ABSTRACT

Described herein is a liquid phosphate-free detergent composition including (A) at least two chelating agents, (A1) one being selected from alkali metal salts of MGDA and GLDA, (A2) one being selected from alkali metal salts of citric acid, (B) at least one anionic surfactant according to general formula (I): CₙH₂ₙ₊₁—O(CH₂CH₂O)ₓ—SO₃M, (C) at least two non-ionic surfactants, (C1) one being selected from alkyl polyglycosides, (C2) and at least one further non-ionic surfactant, the weight ratio of all chelating agent (A) to all anionic surfactant (B) being in the range of from 1:7 to 1:2.5, wherein where: n is a number in the range of from 10 to 18, M is selected from alkali metals, x is a number in the range of from 1 to 5, wherein where said detergent composition has a non-volatile content in the range of from 10 to 30% by weight.

The present invention is directed towards a liquid phosphate-free detergent composition comprising
(A) at least two chelating agents,
   (A1) one being selected from alkali metal and ethanolammonium salts of methyl glycine diacetate and of glutamic acid diacetate,
   (A2) one being selected from alkali metal salts of citric acid,
(B) at least one anionic surfactant according to the general formula (I)

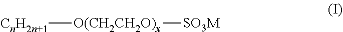

(C) at least two non-ionic surfactants,
   (C1) one being selected from alkyl polyglycosides, and
   (C2) at least one further non-ionic surfactant,
the weight ratio of all chelating agent (A) to all anionic surfactant (B) being in the range of from 1:7 to 1:2.5,
wherein:
n is a number in the range of from 10 to 18,
M is selected from alkali metals and ethanolammonium, preferably sodium,
x is a number in the range of from 1 to 5,
wherein said detergent composition has a total non-volatile content in the range of from 10 to 30% by weight.

Plastic release in the environment has recently been identified as a major threat for the environment. Such plastic is in the ground and in the water. It has been predicted that—provided the plastic release is continued with the same speed—that by 2025, there will be one ton of plastic for every 3 tons of fish in the ocean, and by 2050 the weight of plastic could overtake the weight of fish in the ocean. Of particular relevance is the so-called microplastic, solid polymer particles of which at least 1% by weight of the particles are between 1 nm and 5 mm in all dimensions, because it may find its way to the human body, for example in the food. A specific type of microplastics is called microfibers with lengths from 2 nm to 15 mm and a length to diameter ration of more than 3.

There are multiple ways how microplastic may be released into the environment. A particular relevant path is the release of microfibers during the laundry process, and—in this context—especially the release of synthetic microfibers, for example polyester. While many authors look at parameters such as washing temperature and mechanical parameters of the washing machine, also other parameters may influence the microfiber release, for example the washing detergent. Such a washing detergent should combine good cleaning capability and a reduced microfiber release during laundering.

It was therefore an objective of the present invention to provide a laundry detergent that combines good cleaning capability and a reduced microfiber release during laundering. It was further an objective to provide a process how to make such laundry detergents, and it was an objective to provide a process how to apply such laundry detergents.

Accordingly, the laundry detergents as defined at the outset have been found, hereinafter also referred to as inventive compositions or inventive laundry detergents or as (laundry) detergents according to the (present) invention. Inventive laundry detergents comprise several components, hereinafter also referred to as component (A), component (B), component (C) and, optionally, component (D), or briefly as (A), (B), (C), and (D). Components (A) to (D) will be described in more detail below.

Inventive compositions are liquid. This property refers to normal conditions (25° C., one atmosphere). They appear clear or lightly opaque to the naked eye, and they can be poured like water. In the context of the present invention, gel-type liquid laundry detergents are a special embodiment of liquid laundry detergents. Gel-type liquid laundry detergents usually contain at least one viscosity modifier, and they contain little or no non-aqueous solvents. Gel-type liquid laundry detergents can be directly applied to stains in soiled laundry.

In one embodiment of the present invention, inventive compositions have a dynamic viscosity in the range of from 20 to 20,000 mPa·s, determined at 25° C. according to Brookfield, for example spindle 3 at 20 rpm with a Brookfield viscosimeter LVT-II.

In one embodiment of the present invention, inventive compositions may have a water content in the range of from 50 to 98% by weight, preferably up to 95%.

Inventive compositions are phosphate-free, or—in other words—free from phosphate. “Free from phosphate” should be understood in the context of the present invention, as meaning that the content of phosphate and polyphosphate is in sum in the range from ppm to 1% by weight, determined by gravimetry and referring to the total non-volatile content, preferably 10 ppm to 0.2% by weight or less.

In one embodiment of the present invention, inventive compositions may have a non-volatile content in the range of from 10 to 30% by weight, preferably 15 to 30% by weight. The non-volatile content is determined by evaporation at 105° C. under reduced pressure (“in vacuo”) to constant residue but at least for 2 hours.

In one embodiment of the present invention, inventive compositions may comprise solvents other than water, for example ethanol, n-propanol, iso-propanol, n-butanol, iso-butanol, sec.-butanol, ethylene glycol, propylene glycol, 1,3-propane diol, butane diol, glycerol, diglycol, propyl diglycol, butyl diglycol, hexylene glycol, ethylene glycol methyl ether, ethylene glycol ethyl ether, ethylene glycol propyl ether, and phenoxyethanol, preferred are ethanol, isopropanol or propylene glycol.

In one embodiment of the present invention, inventive compositions comprise 0.5 to 12% by weight of organic solvent, referring to the total respective composition. In embodiments in which inventive composition is provided as unit dose, e.g., in form of a pouch, the content of organic solvent may be in the range of from 8 to 25% by weight, referring to the total respective composition.

In one embodiment of the present invention, inventive compositions have a pH value in the range of from 7 to 11, preferably 7.5 to 9.5, more preferably 8 to 9.

Inventive compositions contain
(A) at least two chelating agents
   (A1) one being selected from alkali metal and ethanolammonium salts of methyl glycine diacetate (MGDA) and of glutamic acid diacetate (GLDA), hereinafter generally also being referred to as complexing agent (A1), and
   (A2) one being selected from alkali metals of citric acid.

In the context of the present invention, alkali metal salts of methylglycine diacetic acid are selected from lithium salts, potassium salts and preferably sodium salts of methylglycine diacetic acid. Examples of ethanolammonium salts of MGDA are the salts of monoethanolamine N,N-diethanolamine or N,N,N-triethanolamine (“triethanolamine”) or N,N-dimethyl-ethanolamine or combinations of at least two of the foregoing. Methylglycine diacetic acid can be partially or preferably fully neutralized with the respective alkali or ethanolamine. In a preferred embodiment, an average of from 2.7 to 3 COOH groups of MGDA is neutralized with alkali metal, preferably with sodium, or with ethanolamine. In a particularly preferred embodiment, chelating agent (A1) is a combination of the disodium and the trisodium salt of MGDA.

Likewise, alkali metal salts of glutamic acid diacetic acid are selected from lithium salts, potassium salts and preferably sodium salts of glutamic acid diacetic acid. Examples of ethanolammonium salts of GLDA are the salts of monoethanolamine N,N-diethanolamine or N,N,N-triethanolamine (“triethanolamine”) or N,N-dimethyl-ethanolamine or combinations of at least two of the foregoing. Glutamic acid diacetic acid can be partially or preferably fully neutralized with the respective alkali or ethanolamine. In a preferred embodiment, an average of from 3.5 to 4 COOH groups of GLDA is neutralized with alkali metal or with ethanolamine, preferably with sodium. In a particularly preferred embodiment, chelating agent (A1) is a combination of the trisodium and the tetrasodium salt of GLDA.

In one embodiment of the present invention, alkali metal salts of MGDA are selected from those of general formula (V)

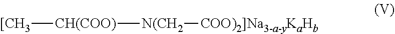

a being selected from 0.0 to 0.5, preferably up to 0.25,
b being selected from 0.0 to 0.5, preferably up to 0.25.

In one embodiment of the present invention, alkali metal salts of GLDA are selected from those of general formula (VI)

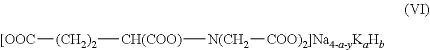

a being selected from 0.0 to 0.5, preferably up to 0.25,
b being selected from 0.0 to 0.5, preferably up to 0.25.

MGDA and its respective salts can be selected from the racemic mixtures, the D-isomers and the L-isomers, and from mixtures of the D- and L-isomers other than the racemic mixtures. Preferably, MGDA and its respective salts are selected from the racemic mixture and from mixtures containing in the range of from 55 to 85 mole-% of the L-isomer, the balance being D-isomer. Particularly preferred are mixtures containing in the range of from 60 to 80 mole-% of the L-isomer, the balance being D-isomer.

The distribution of L- and D-enantiomer can be determined by measuring the polarization (polarimetry) or preferably by chromatography, for example by HPLC with a chiral column, for example with one or more cyclodextrins as immobilized phase. Preferred is determination of the ee by HPLC with an immobilized optically active ammonium salt such as D-penicillamine.

GLDA and its respective salts can be selected from the racemic mixtures, the D-isomers and the L-isomers, and from mixtures of the D- and L-isomers other than the racemic mixtures. Preferably, GLDA and its respective salts are selected from mixtures containing in the range of from 75 to 99 mole-% of the L-isomer, the balance being D-isomer. Particularly preferred are mixtures containing in the range of from 80 to 97.5 mole-% of the L-isomer, the balance being D-isomer.

In any way, minor amounts of chelating agent (A1) may bear a cation other than alkali metal. It is thus possible that minor amounts, such as 0.01 to 5 mol-% of total chelating agent (A1) bear alkali earth metal cations such as Mg²⁺ or Ca²⁺, or an Fe²⁺ or Fe³⁺ cation.

In one embodiment of the present invention, chelating agent (A1) is selected from the trisodium salt of methyl glycine diacetate and the tetrasodium salt of glutamic acid diacetate.

In a special embodiment, inventive compositions may contain a mixture from the sodium salts of MGDA and GLDA.

Alkali metal salts of citric acid (A2) are selected from lithium salts, potassium salts and preferably sodium salts of citric acid, and they may be selected from the mono-, di- and trialkali metal salts of citric acid, and combinations thereof. Preferred are the di- and trisodium salts of citric acid and combinations thereof.

In one embodiment of the present invention, the weight ratio of complexing agent (A1) and (A2) is in the range of from 5:1 to 1:5, preferably 4:1 to 1:4.

Inventive compositions further contain
(B) at least one anionic surfactant according to the general formula (I)

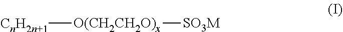

hereinafter also being referred to as surfactant (B) or anionic surfactant (B), with the variables being defined as follows:
n is a number in the range of from 10 to 18, preferably 12 to 14, and even more preferably n=12,
x is a number in the range of from 1 to 5, preferably 2 to 4 and even more preferably 3.
M is selected from alkali metals, preferably potassium and even more preferably sodium, or ethanolammonium.

In surfactant (B), the variables n and x may be average numbers and therefore they are not necessarily whole numbers, while in individual molecules according to formula (I), both n and x denote whole numbers.

In one embodiment of the present invention, inventive compositions contain an additional anionic surfactant, hereinafter also referred to as anionic surfactant (B2).

Examples of anionic surfactants (B2) are alkali metal and ammonium salts of C₈-C₁₂-alkyl sulfates, of C₁₂-C₁₈-fatty alcohol ether sulfates, of sulfuric acid half-esters of ethoxylated C₄-C₁₂-alkylphenols (ethoxylation: 3 to 50 mol of ethylene oxide/mol), of C₁₂-C₁₈-alkylsulfonic acids, of C₁₂-C₁₈ sulfo fatty acid alkyl esters, for example of C₁₂-C₁₈ sulfo fatty acid methyl esters, of C₁₀-C₁₈-alkylarylsulfonic acids, preferably of n-C₁₀-C₁₈-alkylbenzene sulfonic acids, of C₁₀-C₁₈ alkyl alkoxy carboxylates and of soaps such as for example C₈-C₂₄-carboxylic acids. Preference is given to the alkali metal salts of the aforementioned compounds, particularly preferably the sodium salts.

In one embodiment of the present invention, inventive compositions comprise alkali metal salts or amine salts of n-C₁₀-C₁₈-alkylbenzene sulfonic acids, especially sodium or ethanolammonium n-dodecylbenzenesulphonate as anionic surfactant (B2), for example a mixture from the sodium salts of linear 4-dodecylbenzene-sulphonate and linear 5-dodecylbenzenesulphonate. The amount of sodium or ethanolammonium n-dodecylbenzenesulphonate may be in the range of from 10 to 40% by weight referring to the total non-volatile content of said liquid detergent composition.

Ethanolammonium may be selected from to mono-ethanolammonium, N,N-diethanolammonium and N,N,N-triethanolammonium, preference is given to mono-ethanolammonium.

The weight ratio of all chelating agent (A) to all anionic surfactant (B) in inventive compositions is in the range of from 1:7 to 1:2.5. The weight ratio refers to the respective free acids.

Inventive liquid detergent compositions further contain
(C) at least two non-ionic surfactants
   (C1) one being selected from alkyl polyglycosides,
   (C2) and at least one further non-ionic surfactant, hereinafter also being referred to as surfactant (C) or non-ionic surfactant (C).

In one embodiment of the present invention, polyglycoside (C1) is a compound according to formula (III)

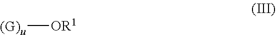

R¹ is selected from C₈-C₁₈-alkyl, straight chain or branched, linear being preferred,
u is in the range of from 1.1 to 4,
G selected from monosaccharides with 4 to 6 carbon atoms, preferably glucose and xylose.

Even more preferred polyglycosides are selected from linear C₄-C₁₆-alkyl polyglucosides and branched C₈-C₁₄-alkyl polyglycosides such as compounds of general average formula (III.1) are likewise suitable.

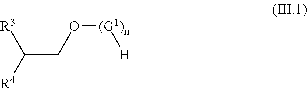

wherein:
R³ is C₁-C₄-alkyl, in particular ethyl, n-propyl or isopropyl,
R⁴ is —(CH₂)₂—R³,
G¹ is selected from monosaccharides with 4 to 6 carbon atoms, especially from glucose and xylose,
u in the range of from 1.1 to 4, u being an average number.

Non-ionic surfactants (C2) are not alkyl polyglycosides.

In one embodiment of the present invention, the at least one further non-ionic surfactant (C2) is selected from compounds according to formula (II a)

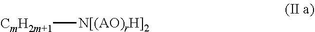

m is a number in the range of from 10 to 18,
r are different or identical and in the range of from 1 to 12,
AO are different or identical and selected from ethylene oxide, propylene oxide, and butylene oxide, and from combinations of at least two of the foregoing,
and from polyalkoxylated fatty alcohols, for example from compounds according to general formula (II b)

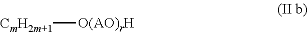

with the variables being defined as above.

In surfactant (C), the variables m and y may be average numbers and therefore they are not necessarily whole numbers, while in individual molecules according to formula (II), both m and y denote whole numbers.

In one embodiment of the present invention, the weight ratio of non-ionic surfactants (C1) and (C2) is in the range of from 5:1 to 1:5, preferably from 2:1 to 1:2.

In one embodiment of the present invention, inventive compositions comprise
(D) at least one compound according to general formula (IV)

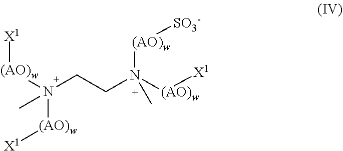

wherein
X¹ are independently selected from H and SO₃M, for example one X¹ being SO₃⁻ and the other two X¹ being H, or two X¹ being SO₃⁻ and the remaining X¹ being H, all X¹ being H, or all X¹ being SO₃⁻, or mixtures of at least two of the foregoing,
w are different or preferably same. The variables w in compound (D) are in the range of from 10 to 30, preferably 20 to 28,
and AO is as defined above.

Preferably, one variable X¹ is SO₃M and the other two are H.

In one embodiment of the present invention, inventive compositions are free from bleaching agents. Bleaching agents in the context of the present invention are organic peroxides, inorganic peroxides and chlorine bleaches. Examples of organic and inorganic peroxides are sodium perborate, anhydrous or for example as monohydrate or as tetrahydrate or so-called dihydrate, sodium percarbonate, anhydrous or, for example, as monohydrate, hydrogen peroxide, persulfates, organic peracids such as peroxylauric acid, peroxystearic acid, peroxy-α-naphthoic acid, 1,12-diperoxydodecanedioic acid, perbenzoic acid, peroxylauric acid, 1,9-diperoxyazelaic acid, diperoxyisophthalic acid, in each case as free acid or as alkali metal salt, in particular as sodium salt, also sulfonylperoxy acids and cationic peroxy acids. chlorine-containing bleaches are, for example, 1,3-dichloro-5,5-dimethylhydantoin, N—N-chlorosulfamide, chloramine T, chloramine B, sodium hypochlorite, calcium hypochlorite, magnesium hypochlorite, potassium hypochlorite, potassium dichloroisocyanurate and sodium dichloroisocyanurate.

“Free from” in the context of bleaching agents means less than 0.5% by weight, referring to the total non-volatile content.

In one embodiment of the present invention, inventive compositions contain at least one alkali metal or ethanolammonium salt of a fatty acid, preferably at least one potassium or ethanolammonium salt of a fatty acid. Examples are the sodium salts and especially the potassium salts of lauric acid, myristic acid, palmitic acid, stearic acid, (hydrogenated) erucic acid and behenic acid, and especially soap mixtures derived from natural fatty acids such as coconut oil fatty acid, palm kernel oil fatty acid, olive oil fatty acid or tallow fatty acid. Preferred examples are potassium coconut soap, potassium stearate, potassium oleate, potassium coconut soap with an average formula of n-C₁₂H₂₅COOK being even more preferred. The amount of potassium salt of fatty acid may be in the range of from 10 to 25% by weight referring to the total non-volatile content of said liquid detergent composition.

Inventive compositions are liquid laundry detergent compositions. They may comprise ingredients other than the aforementioned. Examples are surfactants other than the aforementioned, especially zwitterionic surfactants, furthermore fragrances, dyestuffs, biocides, preservatives, enzymes, hydrotropes, builders, viscosity modifiers, polymers, buffers, defoamers, and anti-corrosion additives.

Examples of fragrances are benzyl salicylate, 2-(4-tert.-butylphenyl) 2-methylpropional, commercially available as Lilial®, and hexyl cinnamaldehyde.

Examples of dyestuffs are Acid Blue 9, Acid Yellow 3, Acid Yellow 23, Acid Yellow 73, Pigment Yellow 101, Acid Green 1, Solvent Green 7, and Acid Green 25.

Inventive liquid detergent compositions may contain one or more preservatives or biocides. Biocides and preservatives prevent alterations of inventive liquid detergent compositions due to attacks from microorganisms. Examples of biocides and preservatives are BTA (1,2,3-benzotriazole), benzalkonium chlorides, 1,2-benzisothiazolin-3-one (“BIT”), 2-methyl-2H-isothiazol-3-one (“MIT”) and 5-chloro-2-methyl-2H-isothiazol-3-one (“CIT”), phenoxyethanol, benzoic acid, sorbic acid, iodopropynyl butylcarbamate (“IPBC”), dichlorodimethylhydantoine (“DCDMH”), bromochlorodimethylhydantoine (“BCDMH”), and dibromodimethylhydantoine (“DBDMH”).

In one embodiment of the present invention, inventive compositions may comprise viscosity modifiers. Examples of viscosity modifiers are agar-agar, carragene, tragacanth, gum arabic, alginates, pectins, hydroxyethyl cellulose, hydroxypropyl cellulose, starch, gelatin, locust bean gum, cross-linked poly(meth)acrylates, for example polyacrylic acid cross-linked with methylene bis-(meth)acrylamide, furthermore silicic acid, clay such as—but not limited to—montmorrilionite, zeolite, dextrin, and casein.

In one embodiment of the present invention, inventive compositions may comprise hydrotropes. Hydrotropes in the context with the present invention are compounds that facilitate the dissolution of compounds that exhibit limited solubility in water. Examples of hydrotropes are organic solvents such as ethanol, isopropanol, ethylene glycol, 1,2-propylene glycol, and glycerol, and further organic solvents that are water-miscible under normal conditions without limitation. Further examples of suitable hydrotropes are the sodium salts of toluene sulfonic acid, of xylene sulfonic acid, and of cumene sulfonic acid.

In one embodiment of the present invention, inventive compositions may comprise one or more enzymes. Examples of of useful enzymes are lipases, hydrolases, amylases, proteases, cellulases, hemicellulases, lipases, phospholipases, esterases, pectinases, lactases and peroxidases, and combinations of at least two of the foregoing types of the foregoing. Particularly useful enzymes are selected from are proteases, amylases, and cellulases.

In one embodiment of the present invention, inventive compositions may comprise one mor more polymers. Examples of polymers are especially polyacrylic acid and its respective alkali metal salts, especially its sodium salt. A suitable polymer is in particular polyacrylic acid, preferably with an average molecular weight M_{w} in the range from 2,000 to 40,000 g/mol. preferably 2,000 to 10,000 g/mol, in particular 3,000 to 8,000 g/mol, each partially or fully neutralized with alkali, especially with sodium. Also of suit-ability are copolymeric polycarboxylates, in particular those of acrylic acid with methacrylic acid and of acrylic acid or methacrylic acid with maleic acid and/or fumaric acid. Polyacrylic acid and its respective alkali metal salts may serve as soil anti-redeposition agents.

Another type of useful copolymers are polyvinylpyrrolidones, copolymers N-vinylpyrrolidone (“NVP”) with N-imidazole, copolymers of acrylic acid with NVP or N-imidazole or with both NVP and N-imidazole. Such (co)polymers may have an average molecular weight Mw in the range of from 5,000 to 100,000 g/mol, determined by gel permeation chromatography. Polyvinylpyrrolidones and copolymers of NVP with N-imidazole and copolymers of acrylic acid with NVP or with N-imidazole may serve as dye transfer inhibitors.

Further examples of polymers are polyethylene terephthalates, polyoxyethylene terphthalates, and polyethylene terephthalates that are end-capped with one or two hydrophilic groups per molecule, hydrophilic groups being selected from CH₂CH₂CH₂—SO₃Na, CH₂CH(CH₂—SO₃Na)₂, and CH₂CH(CH₂SO₂Na)CH₂—SO₃Na.

In one embodiment of the present invention, inventive compositions may comprise a buffer. Examples of buffers are monoethanolamine and N,N,N-triethanolamine.

In one embodiment of the present invention, inventive compositions may comprise a defoamer. Examples of defoamers are silicones.

In one embodiment of the present invention, 50 to at least 85% by weight of the organic compounds contained in inventive compositions are biodegradable. The biodegradability is in accordance with the OECD Guidelines dated 2016, and it is preferably determined as described further down below.

Inventive compositions are particularly useful with respect to the avoidance of microfiber release during laundering, especially polyester microfibers. Inventive compositions may be used in conventional laundering machines, at washing temperatures of from 20 to 65° C. or even more. However, the microfiber release is particularly low at lower temperatures such as 20 C to 40° C. Shorter wash cycles also help to reduce microfiber release.

In order to be suitable as liquid laundry detergent inventive compositions may be in bulk form or as unit doses, for example in the form of sachets or pouches. Suitable materials for pouches are water-soluble polymers such as polyvinyl alcohol.

Another aspect of the present invention is the use of an inventive composition for cleaning laundry. Particularly, an aspect of the present invention is the use of inventive compositions for cleaning laundry, especially laundry made from or containing polyester. Another aspect of the present invention is a process to clean laundry, hereinafter also referred to as inventive process. The inventive process is directed towards cleaning laundry by applying at least one inventive composition, preferably in a washing machine. The inventive process can be performed in an automatic laundry cleaner. Said inventive detergent composition is preferably diluted with water before applying it to the soiled laundry.

In one embodiment of the present invention the inventive process is characterized in that the respective inventive composition is applied to soiled laundry at a temperature in the range of from 20 to 65° C.

By the inventive process—and according to the inventive use as well—such bleachable stains can be removed very efficiently with little or no detectable release of microfibers.

A further aspect of the present invention is a process for making inventive liquid detergent compositions, hereinafter also referred to as inventive method. The inventive method comprises mixing chelating agent (A), surfactant (B) and surfactants (C), and, optionally, further ingredients as outlined above, with water in one or more steps.

The present invention is further illustrated by working examples.

General: the biodegradability tests are carried out in accordance with the OECD 301F Guidelines. According to the OECD 301F guidelines a test is valid if:
1. The reference reaches 60% within 14 days.
2. The difference of the extremes of the test replicates by the end of the test is less than 20%.
3. Oxygen uptake of inoculum blank is 20-30 mg O₂/l and must not be greater than 60 mg O₂/l.
4. The pH value measured at the end of the test must be between 6 and 8.5.

Biodegradation in sewage was tested in triplicate using the OECD 301F manometric respirometry method. OECD 301F is an aerobic test that measures biodegradation of a sewage sample by measuring the consumption of oxygen. To a measured volume of sewage, 100 mg/L test substance, which is the nominal sole source of carbon, was added along with the inoculum (aerated sludge taken from the municipal sewage treatment plant, Mannheim, Germany). This sludge was stirred in a closed flask at a constant temperature (25° C.) for 28 days. The consumption of oxygen is determined by measuring the change in pressure in the closed flask using an Oxi TopC. Carbon dioxide evolved was absorbed in a solution of sodium hydroxide. Nitrification inhibitors were added to the flask to prevent consumption of oxygen due to nitrification. The amount of oxygen taken up by the microbial population during biodegradation of the test substance (corrected for uptake by a blank inoculum run in parallel) is expressed as a percentage of ThOD (theoretical oxygen demand, which is measured by the elemental analysis of the compound). A positive control glucose/glutamic acid is run along with the test samples for each cabinet as reference.

### Calculations:

Theoretical oxygen demand: Amount of O₂ required to oxidize a compound to its final oxidation products, e.g., H₂O, CO₂. This is calculated using the elemental analysis data.

### % Biodegradation

Experimental O₂ uptake. 100 and divided by the theoretical O₂ demand

### EXPERIMENTAL

### General Remarks:

The tests for microfiber release were carried out as follows:

All main washing tests were carried out with a Girbau HS6013 automatic type A front-loading washing machine equipped with an adjacent 175 liter outside water collector tank for collecting the wastewater.

The fresh water was passed through a water softener to produce a water hardness below 20 mg CaCO₃/liter 100 to 400 g of test specimen, 92 cm·65 cm, single-side fabric, confectioned in a handkerchief model style, were laundered per run, with 15 g of test detergent.

In addition to the aforementioned load and detergent dosage, tests including higher load (from 0.5 kg to 6 kg) and higher detergent dosage from 15 g till 100 g of test detergent were performed to check its influence.

The program “conventional domestic3” was used, maximum temperature 40° C., washing speed 44 revolutions per minute (“rpm”), three phases: washing, first rinsing, second rinsing including centrifuging with 1,000 rpm, total time: 56 minutes. In addition to the washing step, a cleaning step without fabric was added to collect all potential remaining fibers across washings.

In order to evaluate the performance in low temperature and shorter cycles, a program “delicate program” was used, maximum temperature 20° C., washing speed 44 revolutions per minute (“rpm”), three phases: washing, first rinsing, second rinsing including centrifuging in 800 rpm, total time: 30 minutes. In addition to the washing step, a cleaning step without fabric was added to collect all potential remaining fibers across washings.

The combined wastewater that includes the washing and cleaning water was filtered with a two-filter system consisting of two circle-shape filters: a stainless steel filter, diameter 28 cm, pore size 1 mm, and a 12 mm diameter nylon filter, mesh size 20 μm.

The filtering was accelerated with the help of a vacuum pump. The filter residue from the steel filter was removed with a tweezer. The filter residue on the nylon filter was determined by weight determination of the nylon filter before and after filtration.

After each test, both the washing machine and the water collector tank were cleaned diligently to avoid cross-contamination.

### I: Manufacture of Inventive Compositions and Comparative Compositions

The following substances were used:
(A1.1): MGDA-Na₃ as 40% aqueous solution
(A1.2): GLDA-Na₄ as 47% aqueous solution
(A2.1): trisodium salt dihydrate of citric acid
(B.1): n-C₁₂H₂₅—O—(CH₂CH₂O)₃—SO₃Na, thus, in formula (I): n=12, x=3
(B2.1): n-dodecylbenzenesulfonic free acid, to be in situ neutralized with N-ethanolamine
(C1.1): n-C₁₀-C₁₆-alkyl-polyglucoside, u=1.3
(C2.1): n-C₁₈H₃₇—O(CH₂CH₂O)₇—H, m=12, r=7
(C2.2): C₁₂H₂₅—N[(AO)₂H]₂, m=12, r=2

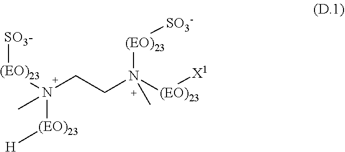

with EO=CH₂CH₂—O (ethylene oxide). It is understood that 23 is an average number

Polymer P1: copolymer of NVP and N-vinylimidazole, Mw: 70.000 g/mol Soap: mixture of C14- to C18-fatty acids derived from palm kernel oil, acid value 250 mg KOH/g, iodine value 18% I₂ absorbed, commercially available as Wilfarin DK-1218

Manufacture of inventive compositions, COMP.1 and COMP.2 and COMP.3:

All amounts according to Table 1.

A vessel was charged with anionic surfactant (B2.1). Glycerol, 1,2-propylene glycol and some 95% of the water were added and the resultant mixture was heated to 50° C. under stirring. The soap and monoethanolamine were added carefully to avoid any heating beyond 65° C. The resultant solution had a pH value of 9. Chelating agents (A.1) and (A.2) were added to the mixture so obtained. Surfactant (B.1) as a 40° C. warm solution and surfactants (C1.1) and (C2.1) or (C2.2) were added. Then, the heating was set off, and the pH value was set to 8.5 with citric acid. Then, the ingredients other than water according to Table 1 were added. The pH value was set to 8.5 again, with citric acid or monoethanolamine, as the case may be. Then, the balance of water was added under stirring to complete to 100% of the total amount to compensate evaporated during the manufacturing process.

TABLE 1
ingredients of inventive compositions
COMP. 1to COMP. 3 and COMP. 10

| component | COMP. 1 | COMP. 2 | COMP. 3 | COMP. 10 |
|---|---|---|---|---|
| (A1.1) | 5.0 | 5.0 | 5.0 | — |
| (A.1.2) | — | — | — | 5.0 |
| (A2.1) | 1.3 | 1.3 | 1.3 | 1.3 |
| (A2.1) as free acid | 1.83 | 1.75 | 1.58 | 1.0 |
| (B.1) | 7.5 | 7.5 | 4.5 | 7.5 |
| (B2.1) | 7.5 | 7.5 | 4.5 | 7.5 |
| (C1.1) | 3.33 | 3.33 | 2.0 | 3.33 |
| (C2.1) | — | 4.17 | 2.5 | — |
| (C2.2) | 5.21 | — | — | 5.21 |
| (D.1) | — | 3.0 | — | — |
| P1 | 0.2 | 0.2 | 0.2 | 0.2 |
| monoethanolamine | 2.9 | 2.9 | 1.6 | 2.9 |
| 1,2-propandiol | 6.0 | 6.0 | 6.0 | 6.0 |
| glycerol | 2.0 | 2.0 | 2.0 | 2.0 |
| Soap | 2.5 | 2.5 | 1.5 | 2.5 |
| protease | 0.35 | 0.35 | 0.35 | 0.35 |
| Preservative | 0.5 | 0.5 | 0.5 | 0.5 |
| Water | Add 100 | Add 100 | Add 100 | Add 100 |

All amounts refer to active ingredients and g/100 g composition

The following comparative compositions were made, see Table 2. The general protocol of the above inventive compositions was basically followed but at least one agent was left out or replaced.

TABLE 2
ingredients of Comparative Compositions C-COMP. 4 to C-COMP. 9

| component | C-COMP. 4 | C-COMP. 5 | C-COMP. 6 | C-COMP. 7 | C-COMP. 8 | C-COMP. 9 |
|---|---|---|---|---|---|---|
| (A1.1) | — | — | — | — | — | — |
| (A2.1) | 1.3 | 1.3 | 1.3 | 1.3 | 1.3 | 1.4 |
| (A2.1), free acid | To pH 8.5 | To pH 8.5 | To pH 8.5 | To pH 8.5 | To pH 8.5 | 1.66 |
| (B.1) | 4.5 | 4.5 | 4.5 | 4.5 | 4.5 | 7.5 |
| (B2.1) | 4.5 | 4.5 | 4.5 | 4.5 | 4.5 | 7.5 |
| (C1.1) | 2.0 | 2.0 | 2.0 | 2.0 | — | 3.3 |
| (C2.1) | 2.5 | 2.5 | 2.5 | — | 4.5 | 4.2 |
| (C2.2) | — | — | — | — | — | — |
| P1 | 0.2 | 0.2 | 0.2 | 0.2 | 0.2 | 0.2 |
| P2 | — | — | 1.25 | — | — | — |
| P3 | — | 1.25 | — | — | — | — |
| P4 | 0.5 | — | — | — | 0.5 | 0.5 |
| W1 | — | — | — | 1.5 | — | |
| HEDP | 1.0 | 1.0 | 1.0 | 1.0 | 1.0 | 1.0 |
| MEA | 1.7 | 2.1 | 1.7 | 1.8 | 1.8 | 2.9 |
| 1,2-propandiol | 6.0 | 6.0 | 6.0 | 6.0 | 6.0 | 6.0 |
| glycerol | 2.0 | 2.0 | 2.0 | 2.0 | 2.0 | 2.0 |
| HEDP | 1.0 | 1.0 | 1.0 | 1.0 | 1.0 | 1.0 |
| Soap | 1.5 | 1.5 | 1.5 | 1.5 | 1.5 | 2.5 |
| protease | 0.35 | 0.35 | 0.35 | 0.35 | 0.35 | 0.35 |
| Preservative | 0.5 | 0.5 | 0.5 | 0.5 | 0.5 | 0.5 |
| Water | Add 100 | Add 100 | Add 100 | Add 100 | Add 100 | Add 100 |

HEDP: 2-hydroxyethyl phosphonic acid, di-sodium salt, MEA: monoethanolamine P2: random copolymer from methacrylamide and diallyldimethylammoniumchlorid (“DADMAC”), M_{w} 1.15 to 1.9·106 g/mol (GPC)

P3: Modified polyethylenimine: Example B.1.3.1 of WO 2013/160259

P4: Polyquaternium 44, random 3-(methyl-1-vinylimidazolium methyl sulfate-N-vinylpyrrolidone copolymer, Mw 200,000 g.

Wax dispersion W1: mixture from glycol distearate, glycerol oleate, glycerol stearate, and coco glucoside

The following polyester-containing textiles were used:
MMF: Medium Microfiber Release, t-shirt fabric type, polyester cotton blend, staple fiber, knitted plain fabric.
HMF: High Microfiber Release, hairy jacket fabric type, polyester continuous filament fibre, knitted grinded fabric
MHMF (Medium High Microfiber Release): jumper fabric type, polyester, staple fiber, knitted raised fabric.
vHMF (Very High Microfibre Release): jumper fabric type, polyester cotton blend, staple fibre, knitted grinded fabric

In addition, two commercially available liquid laundry detergents were tested, CALL-1 and CALL-2. Both contained neither (A.1) nor (C1.1).

The microfiber release for Table 3 was determined by filtering the washing liquor after washing through a set of four sieves: three stainless steels filters, diameter 28 cm, assembled together, mesh 1000 μm, 400 μm, 100 μm, and a 12 mm diameter nylon filter, mesh size 20 μm. The microfiber release in Table 4 and 5 was determined by filtering the washing liquor after washing through a set of two sieves, mesh 1000 μm and 20 μm. The release was determined in g microfibers/kg laundry in one wash. The values were in each case average values from 3 washes. The microfiber release in Table 5 was determined using different temperatures and time of washing cycle with a single washing load.

TABLE 3
Average microfiber release

| | water | CALL-1 | COMP. 3 | C-COMP. 4 | C-COMP. 5 | C-COMP. 6 | C-COMP. 7 | C-COMP. 8 |
|---|---|---|---|---|---|---|---|---|
| HMF | 0.81 | 1.52 | 0.63 | 1.09 | 1.30 | 0.78 | 0.95 | 0.98 |
| MMF | 1.75 | 1.17 | 0.53 | 1.10 | 0.91 | 1.02 | 0.68 | 0.80 |

TABLE 4
Average microfiber release

| | Water | CALL-1 | CALL-2 | C-COMP. 9 | COMP. 1 | COMP. 2 | COMP. 10 |
|---|---|---|---|---|---|---|---|
| HMF | 0.40 | 0.51 | 0.66 | 0.45 | 0.23 | n.d. | 0.22 |
| MMF | 0.57 | 0.60 | 0.51 | 0.49 | 0.45 | 0.34 | n.d. |
| vHMF | 3.08 | 1.66 | 0.98 | n.d. | 0.29 | 0.35 | n.d. |

n.d.: not determined

TABLE 5
Average microfiber release

| | CALL-1 | COMP. 1 | COMP. 1 |
|---|---|---|---|
| | 40° C./60 min | 40° C./60 min | 20° C./30 min |
| MMF | 0.60 | 0.45 | 0.25 |
| MHMF | 0.75 | 0.28 | 0.15 |
| vHMF | 1.66 | 0.29 | 0.22 |

1. A liquid phosphate-free detergent composition comprising
(A) at least two chelating agents,
(A1) one being selected from the group consisting of alkali metal salts of citric acid,
(B) at least one anionic surfactant according to the general formula (I) 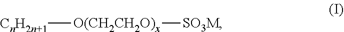
(C) at least two non-ionic surfactants,
(C1) one being selected from the group consisting of alkyl polyglycosides, and
(C2) at least one further non-ionic surfactant,
the weight ratio of all chelating agent (A) to all anionic surfactant (B) being in the range of from 1:7 to 1:2.5,
wherein:
n is a number in the range of from 10 to 18,
M is selected from the group consisting of alkali metals and ethanolammonium, and
X is a number in the range of from 1 to 5,
wherein a second chelating agent is
(A2) selected from the group consisting of alkali metal and ethanolammonium salts of methyl glycine diacetate (MGDA) and of glutamic acid diacetate (GLDA),
wherein said detergent composition has a total non-volatile content in the range of from 10 to 30% by weight, wherein the total non-volatile content is determined by evaporation at 105° C. in vacuo to constant residue but at least for 2 hours.

2. The composition according to claim 1, wherein the at least one further non-ionic surfactant (C2) is selected from the group consisting of compounds according to formula (II) 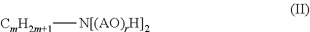
wherein:
m is a number in the range of from 10 to 18,
r are different or identical and in the range of from 1 to 12, and
AO are different or identical and selected from the group consisting of ethylene oxide, propylene oxide, and butylene oxide, and combinations of at least two of the foregoing,
and polyalkoxylated fatty alcohols.

3. The composition according to claim 1, wherein chelating agent (A2) is selected from the group consisting of the trisodium salt of methyl glycine diacetate and the tetrasodium salt of glutamic acid diacetate.

4. The composition according to claim 1, wherein M in formula (I) is sodium.

5. The composition according to claim 1, wherein said composition additionally contains at least one fatty acid or its alkali metal salt.

6. The composition according to claim 1, wherein said composition additionally comprises
(D) at least one compound according to general formula (IV) 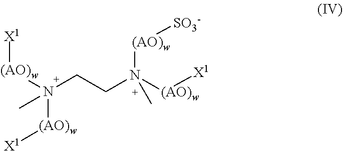
wherein:
X¹ are independently selected from the group consisting of H and SO₃,
w are the same or different and in the range of from 10 to 30, and
and AO are different or identical and selected from the group consisting of ethylene oxide, propylene oxide, and butylene oxide, and combinations of at least two of the foregoing.

7. The composition according to claim 1, wherein said liquid detergent composition comprises
(A) in total in the range of from 3 to 30% by weight of chelating agent,
(B) in the range of from 25 to 70% by weight of anionic surfactant, and
(C) in total in the range of from 10 to 40% by weight of non-ionic surfactants,
with percentages referring to the non-volatiles content of said liquid detergent composition.

8. The composition according to claim 1, wherein the variable n is 12.

9. The composition according to claim 1, wherein said composition is free from bleaching agents.

10. The composition according claim 1, wherein from 50 to 95% of all organic compounds contained therein are biodegradable.

11. The composition according to claim 1, wherein having a dynamic viscosity in the range of from 20 to 20,000 mPa's, determined at 25° C. according to Brookfield, spindle 3 at 20 rpm with a Brookfield viscosimeter LVT-II.

12. A process for cleaning laundry, wherein a composition according to claim 1 is applied to soiled laundry at a temperature in the range of from 20 to 65° C.

13. A method of using the composition according to claim 1, the method comprising using the composition to reduce microfiber release during laundering.

14. A process for manufacturing the composition according to claim 1, wherein said process comprises mixing the components (A) to (C) and neutralizing any acidic component with ethanolamine.
